(19) United States
(12) Patent Application Publication
(10) Pub. No.: US 2017/0068061 A1
(43) Pub. Date: Mar. 9, 2017

(54) DETACHABLE HIGH-SPEED TRANSMISSION CABLE AND MODULE THEREOF

(71) Applicants: Jui-Ming Yang, New Taipei City (TW); Chia-Chien Chen, New Taipei City (TW); Yen-Tung Chen, New Taipei City (TW)

(72) Inventors: Jui-Ming Yang, New Taipei City (TW); Chia-Chien Chen, New Taipei City (TW); Yen-Tung Chen, New Taipei City (TW)

(21) Appl. No.: 14/846,985

(22) Filed: Sep. 7, 2015

(51) Int. Cl. G02B 6/44; H01R 24/64; H01R 24/28; G02B 6/42; G02B 6/38

(52) U.S. Cl. CPC G02B 6/4416; G02B 6/4284; G02B 6/4292; G02B 6/3882; H01R 24/28; H01R 24/64; H01R 2107/00

(57) ABSTRACT

A high-speed transmission cable module includes: a transmission cable, having at least one optical fiber wire, and one end or two ends of the optical fiber wire being respectively in optical connection with a optical fiber joint; and at least one transmission device, having an optical fiber socket capable of being in optical connection with the optical fiber joint of the transmission cable and a transmission joint of standard transmission interface, wherein signals of the optical fiber socket is transmitted directly or transmitted by means of transformation to the transmission joint. Whereby, the transmission cable and high-speed transmission device being detachable can solve the difficulties of conventional wiring construction within a pipeline.

### (a) TECHNICAL FIELD OF THE INVENTION

The present invention relates to a high-speed transmission cable and a module thereof, and more particularly to a detachable high-speed transmission cable and a module thereof.

### (b) DESCRIPTION OF THE PRIOR ART

High definition multimedia interfaces (HDMI) are a kind of fully digitized image and sound transmission interface, capable of transmitting uncompressed audio and video signals, and being used in DVD players, digital stereos, television game machines, set top boxes, personal computers or the like; the system line installation difficulty can be simplified greatly because the same cable is adopted for audio and video signals.

The maximum pixel transmission rate of early HDMI is 165M pixel/sec or 4.95G bps sufficient to support 1080p picture quality in 60 pictures/sec, or the definition of UXGA (1600×1200). Thereafter, the pixel transmission rate is increased to 340 pixel/sec in the specifications of HDMI 1.3, and the running speed is up to 10.2G pbs, and further up to 18G bps for HDMI 2.0.

The high-speed transmission speed provides high definition picture and high sound qualities. However, the cable attenuation of high-frequency signals causing the limitation of the lengths of HDMI cables to be one of the main issues of the application thereof. Existing 10M cables passing the HDMI authentication are mostly manafactued from 24AWG (American Wire Gauge) wires, and if HDMI copper lines are made according to the standard 28AWG specification of a thinner wire diameter, signals are attenuated approximately after transmitted beyond 5 meters; the length (5 meters) is always insufficient to meet the connection application requirement of the image transmission of computers to projectors. Increasing the diameter of the copper lines in a cable to decrease impedance is one of the manners for lengthening the cable, but the coarser cables cause the difficulties in the construction of the pipeline wiring.

Another prior art in solving the issues is to use HDMI optical fiber lengthener; the electric signals of HDMI are first transformed into optical signals, and the audio and video optical signal are transmitted remotely through optical fibers with extremely low attenuation and then transformed back to electric signals. Accordingly, it is capable of breaking through the distance limitation of HDMI wires. It is well known that one advantage of using optical fibers rather than copper lines to transmit signals is that an optical fiber is smaller than a copper line in diameter, and the number of optical fibers is much fewer than the one of copper lines under the same transmission capacity such that the diameter of the HDMI cable lengthener introducing HDMI optical fibers is much smaller than the one of a conventional HDMI cable consisting of copper lines. But, because the joints at the two ends of the cable respectively need an electronic-to-optical transducer and optical-to-electronic transducer, it causes that the sections of the joints are much larger than the section of the cable, and results in the difficulties in the construction of the pipeline wiring, too.

In addition, if a user changes a video/audio device, causing the type of the joints thereof to be changed, the whole conventional HDMI cable needs to be changed. Furthermore, an old cable must be replaced with a new one due to the insufficient length thereof even if a video/audio device is not replaced but only the erection position thereof is changed, resulting in waste.

Although Taiwan Patent Publishing No.: M422079 titled as “universal modular connector” and Taiwan Patent Publishing No. M422178 titled as “photoelectric signal conversion module” disclose the technologies of transforming optical signals into electric signals via the photoelectric signal conversion module and connecting it to different connecting terminals, the two patents are used in circuit boards rather than cables.

### SUMMARY OF THE INVENTION

The present invention proposes a detachable high-speed transmission cable, capable of solving the difficulties of conventional wiring construction within a pipeline in a way that a transmission cable can be separated and detached, as such, only the transmission cable portion need be replaced when the length of the cable is changed so as to be convenient for use. Naturally, a detachable high-speed transmission cable module of the present invention can solve the difficulties of conventional wiring construction within a pipeline in a way that the transmission joint can be separated and detached. In addition, various types of joints may be replaced in response to various applications depending on requirements because the transmission cable and transmission joint can be separated and detached at will according to the present invention, for example, the communation joint may be replaced directly by a HDMI joint or an USB joint depending on the requirements of devices or site construction, or it may be replaced directly various types of joints, and a HDMI joint may even be connected to one end of a cable and a USB joint connected to another end thereof, or a standard joint may be connected to only one end of a cable and no joint connected to another end thereof.

Furthermore, the above detachable high-speed transmission cable and the module thereof may provide a video/audio device or communication equipment with electric power and signal transmission simultaneously.

In addition, the present invention includes a high-speed transmission cable 100 and high-speed transmission device 200, and the ways for the high-speed transmission device 200 to obtain electric power needed for operation are:
1. connecting an external power line 300 to an external power joint 205 of the high-speed transmission device 200;
2. enabling power transmission from a conducting joint 103 of the high-speed transmission cable 100 with a conducting joint 203 of the high-speed transmission device 200; or
3. connecting the external power line 300 to the external power joint 205 of the high-speed transmission device 200 and connecting the conducting joint 103 of the high-speed transmission cable 100 to the conducting joint 203 of the high-speed transmission device 200 at the same time.

The signal transmission of the present invention can be enabled only by connecting an optical fiber joint 104 of the high-speed transmission cable 100 to an optical fiber socket 204 of the high-speed transmission device 200, and making signals pass through a support 206 on which the components of the high-speed transmission device 200 are mounted and transmit to the transmission joint 201, thereby outputting the signals.

### BRIEF DESCRIPTION OF THE DRAWINGS

FIG. 1 is an exploded view of a first preferred embodiment of a high-speed transmission cable and a module thereof according to the present invention;

FIG. 2 is a schematically perspective view of a first preferred embodiment of a high-speed transmission cable according to the present invention;

FIG. 3 is a partly enlarged view of FIG. 2;

FIG. 4 is a schematically perspective view of a second preferred embodiment of a high-speed transmission cable according to the present invention;

FIG. 5 is a partly enlarged view of FIG. 4;

FIG. 6 is a schematically perspective view of a first preferred embodiment of a high-speed transmission device according to the present invention;

FIG. 7 is a schematically perspective view of a high-speed transmission cable and a module thereof in connection with a optical fiber wire and external power line of the high-speed transmission cable according to the present invention;

FIG. 8 is a schematically perspective view of a high-speed transmission device according to the present invention′

FIG. 9 is an exploded view of a second preferred embodiment of a high-speed transmission cable and a module thereof according to the present invention;

FIG. 10 is a schematically perspective view of a high-speed transmission cable and a module thereof in connection with an optical fiber wire and electrical conductor of the high-speed transmission cable;

FIG. 11 is a schematically perspective view of a third preferred embodiment of a high-speed transmission device according to the present invention;

FIG. 12 is a schematically perspective view of a high-speed transmission cable and a module thereof in connection with an optical fiber wire, electrical conductor and external power line of the high-speed transmission cable according to the present invention; and

FIG. 13 is schematically perspective view of the present invention in which the transmission joint is a USB.

### DETAILED DESCRIPTION OF THE PREFERRED EMBODIMENTS

The aforementioned and other objectives and advantages of the present invention will become clearer in light of the following detailed description of an illustrative embodiment of this invention described in connection with the drawings. It is intended that the embodiments and drawings disclosed herein are to be considered illustrative rather than restrictive.

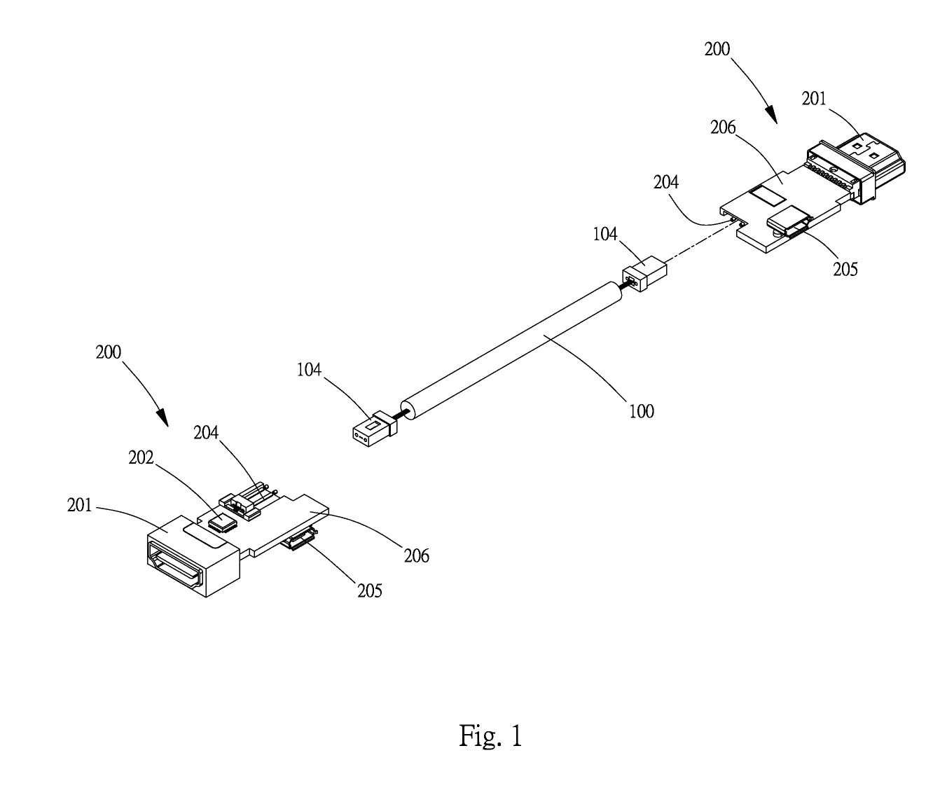

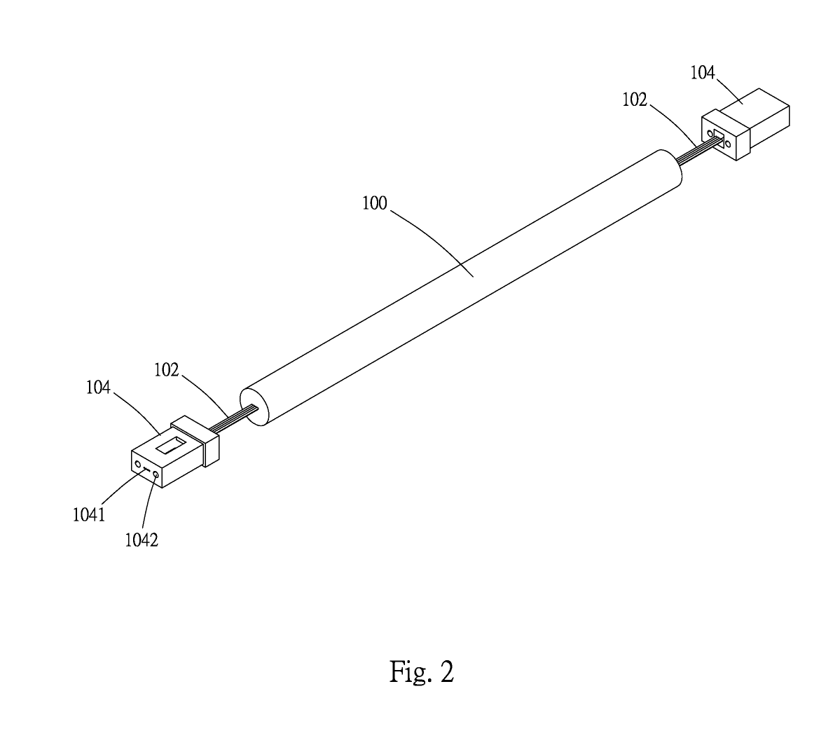

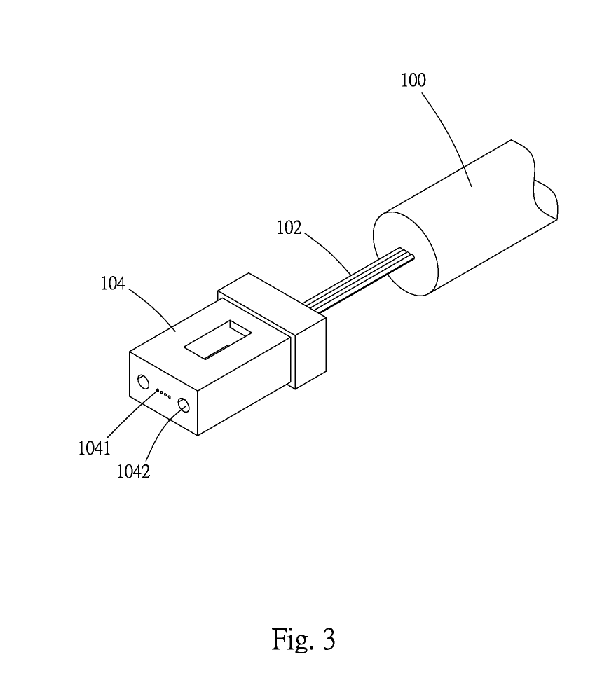

Referring to FIGS. 1 to 3 first, the present invention is a detachable high-speed transmission cable and a module thereof. The module includes a transmission cable 100 and at least one high-speed transmission device 200; the both of which may have different types of joints for different uses and replacements, the detailed exemplified combinations and arrangements will be described hereinafter.

The transmission cable 100 has at least one optical fiber wire 102, and one end or two ends of which are respectively coupled with one or two optical fiber joints 104 which is configured with optical fiber wires 1041 and guide holes 1042.

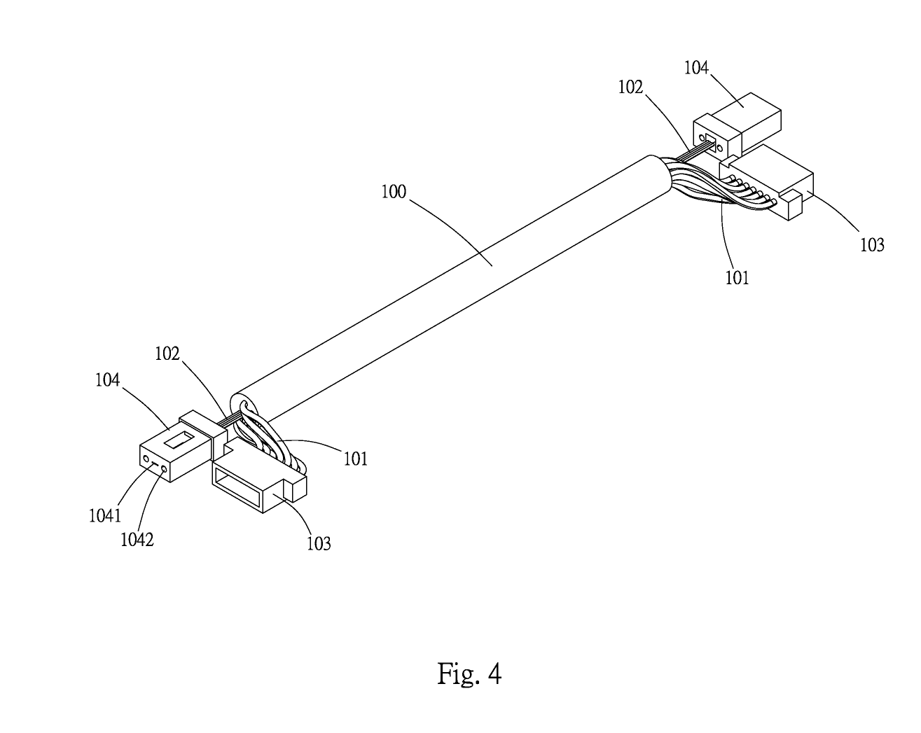

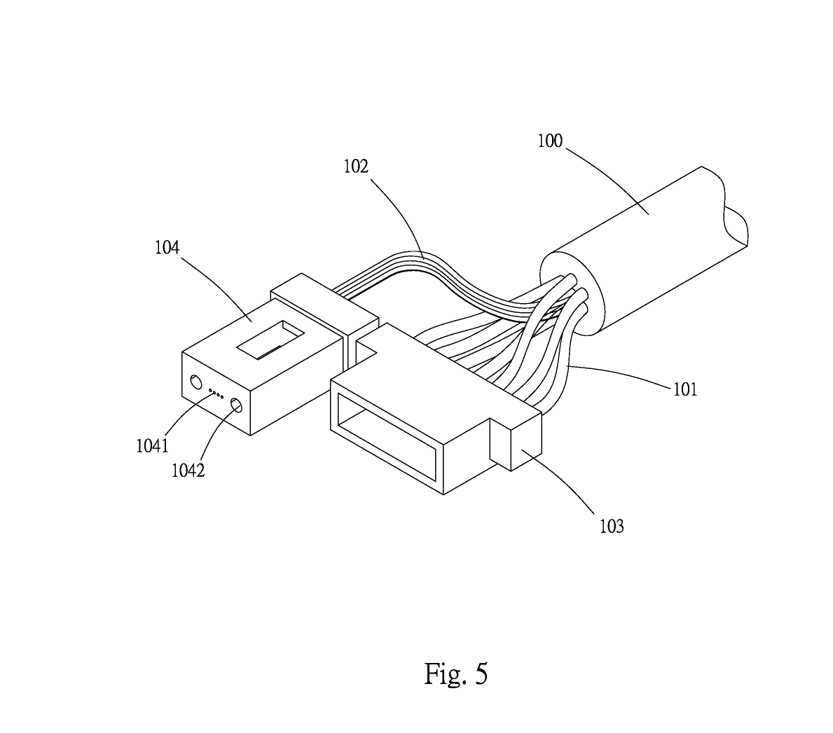

Furthermore, referring to FIGS. 4 and 5, in a second preferred embodiment of a transmission cable, the transmission cable 100 further includes at least one electrical conductor 101, where one end or two ends of the electrical conductor 101 are respectively in electric connection with a conducting joint 103 and one end or two ends of the optical fiber wire 102 an optical fiber joint 104. Namely, the electrical conductor 101 is in electric connection with the conducting joint 103, and the optical fiber wire 102 is in optical connection with the optical fiber joint 104, where the intermediate area between the electric wires 101 and optical fiber wires 102 is wrapped commonly by a wire cladding skin, and the two ends thereof from which the cladding skin is removed are then respectively in electric and optical connection with the conducting joint 103 and optical fiber joint 104. Furthermore, the optical fiber joint 104 is configured with optical fiber wires 1041 and guide holes 1042.

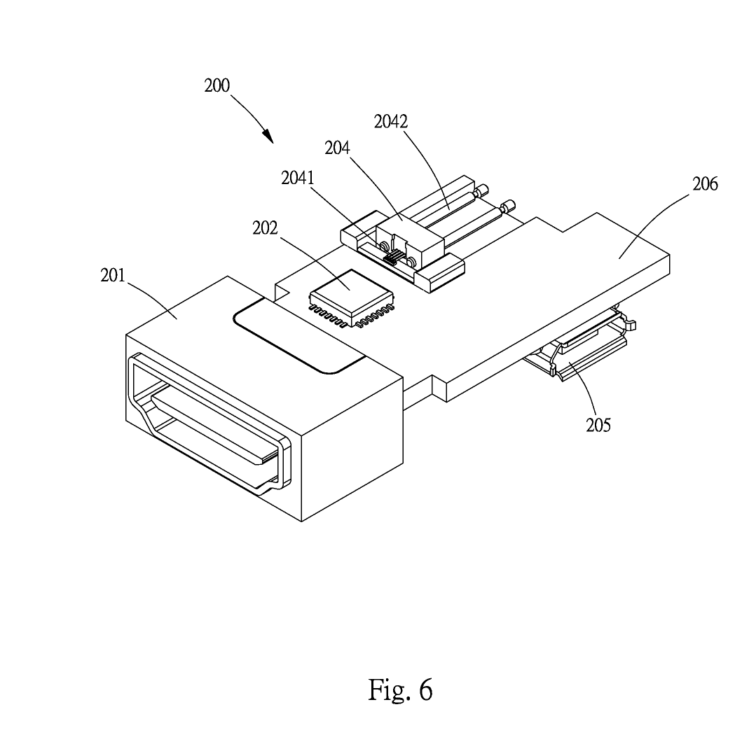

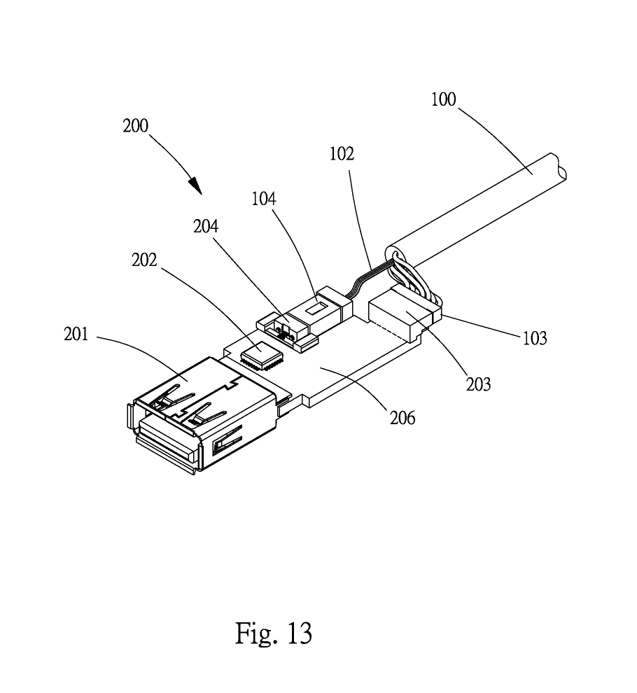

Next, referring to FIG. 6, in a first preferred embodiment of a high-speed transmission device according to the present invention, a high-speed transmission device 200 includes an optical fiber socket 204, transmission joint 201 of standard transmission interface, photoelectric conversion element 202, external power joint 205 and support 206, where the optical fiber socket 204 configured on the support 206 includes optical fiber wires 2041 and guide elements 2042, the guide elements 2042 being inserted in the guide holes 1042 of the optical fiber joint 104, such that the optical fiber wires 1041 of the optical fiber joint 104 are allowed to be coupled to the optical fiber wires 2041 of the optical fiber socket 204. Furthermore, the photoelectric conversion element 202 is also mounted on the support 206 and respectively coupled to the transmission joint 201 and optical fiber socket 204, the transmission joint 201 being configured on another end of the support 206 and being a HDMI joint, USB join (see FIG. 13) or other kinds of standard transmission interface joints.

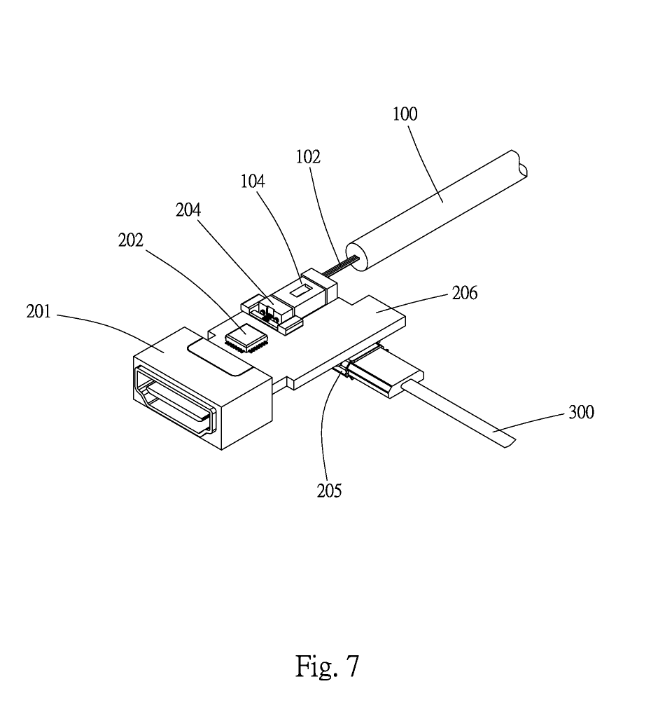

Further, referring to FIGS. 1 and 7, which respectively are an exploded view and a perspective view after assembly of a first embodiment of a high-speed transmission cable and a module thereof according to the present invention, the optical fiber joint 104 of the transmission cable 100 is inserted in the optical fiber socket 204, allowing the optical fiber wires 1041 of the optical fiber joint 104 to be in optical connection with the optical fiber wires 2041 of the optical fiber socket 204, and the signals in the transmission cable 100 can be transmitted directly through the optical fiber joint 104 or transmitted by means of the transformation of the photoelectric conversion element 202 to the transmission joint 201. The external power joint 205 is configured on one side of the support 206, thereby allowing the joint 205 to be in connection with an external power line 300 so as to provide external power for the high-speed transmission device 200.

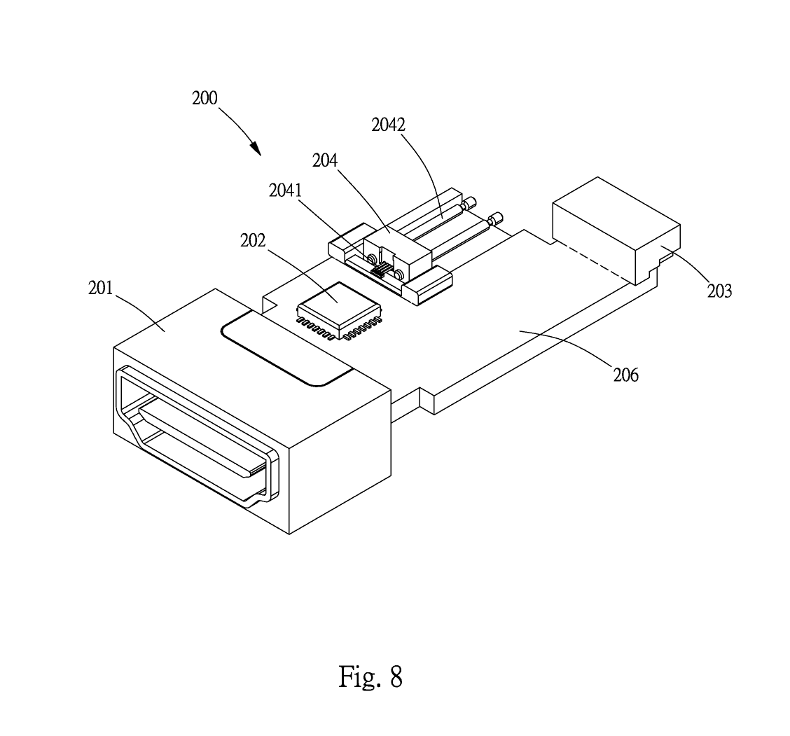

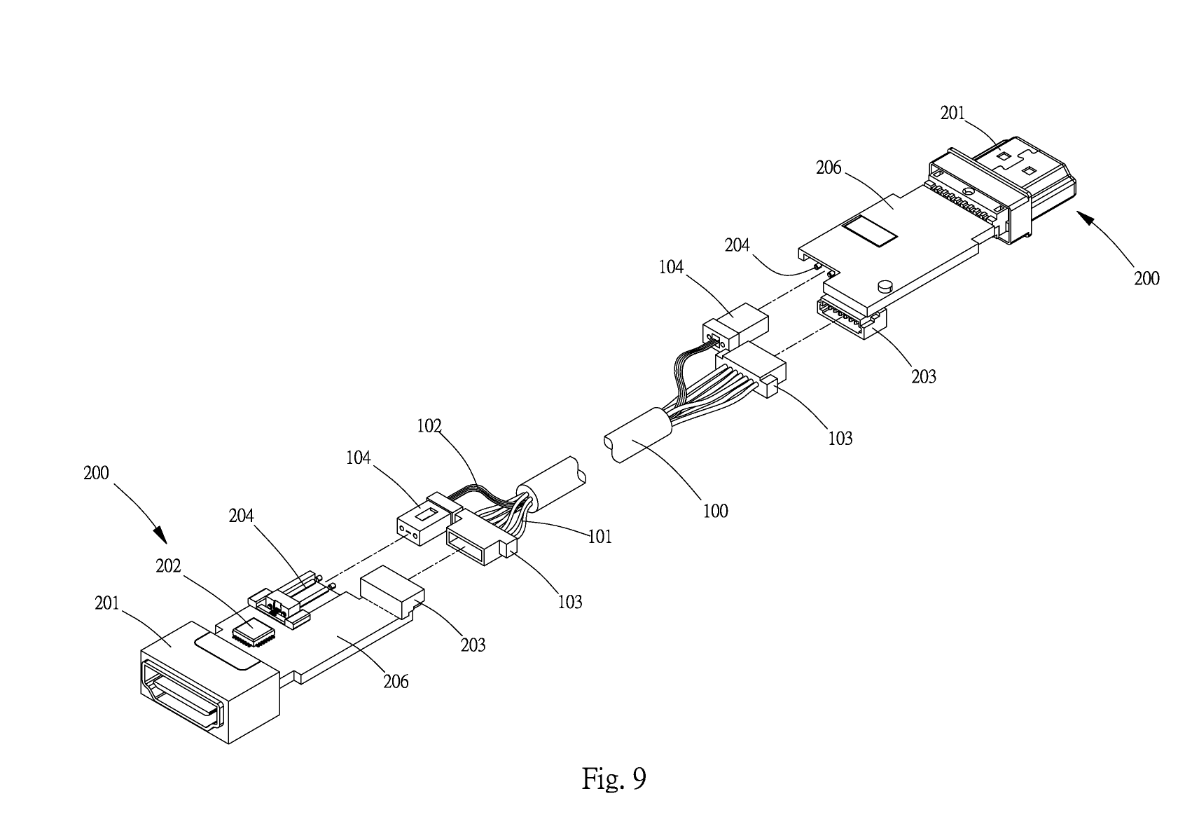

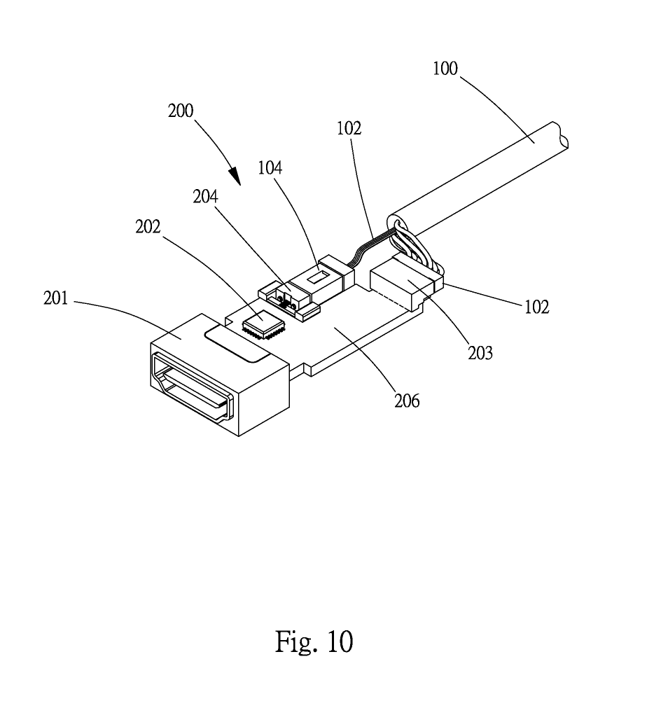

Furthermore, referring to FIG. 8, which is a second embodiment of a high-speed transmission device according to the present invention, in the high-speed transmission device, the external power source joint 205 is replaced with a power source joint 203 which is arranged to configure on one end of the support 206. Further, referring to FIGS. 9 and 10, which respectively are an exploded view and a perspective view after assembly of a second embodiment of a high-speed transmission cable and a module thereof according to the present invention, the transmission cable further includes at least one electrical conductor 101, one end or two ends of the electrical conductor 101 respectively are in electric connection with a conducting joint 103, and the optical fiber joint 104 of the transmission cable 100 is inserted in the optical fiber socket 204 of the high-speed transmission device 200, thereby allowing the optical fiber wires 1041 of the optical joint 104 to be in optical connection with the optical fiber wires 2041 of the optical fiber socket 204, and the signals in the transmission cable 100 can be transmitted directly through the optical fiber joint 104 or transmitted by means of the transformation of the photoelectric conversion element 202 to the transmission joint 201. The joint 203 is configured on one side of the support 206, thereby allowing the joint 203 to provide power for the high-speed transmission device 200 directly.

The present invention is a detachable high-speed transmission cable and a module thereof, including a transmission cable 100 and at least one high-speed transmission device 200. The high-speed transmission device 200 may have different kinds of joints such as HDMI joint, USB joint, thereby allowing the selections and replacements for different uses, and the exemplified detailed combinations and arrangements will be described hereinafter.

The transmission cable 100 includes at least one electrical conductor 101 and at least one optical fiber wire 102, and one end or two ends of the electrical conductor 101 respectively are in electric connection with a conducting joint 103 and one end or two ends of the optical fiber wire 102 respectively are in optical connection with a optical fiber joint 104, where the electrical conductor 101 is in electric connection with the conducting joint 103, while the optical fiber wire 102 is in optical connection with the optical fiber joint 104, and the optical fiber wire 102 is in optical connection with the optical fiber joint 104, where the intermediate area between the electric wires 101 and optical fiber wires 102 is wrapped commonly by a wire cladding skin, and the two ends thereof from which the cladding skin is removed, so that the electric wires 101 and optical fiber wires 102 can then be respectively in electric and optical connection with the conducting joint 103 and optical fiber joint 104.

Furthermore, the high-speed transmission device 200 includes an optical fiber socket 204, transmission joint 201 of standard transmission interface, photoelectric conversion element 202, external power joint 205 and support 206, where the optical fiber socket 204 configured on the support 206 includes optical fiber wires 2041 and guide elements 2042, the guide elements 2042 being inserted in the guide holes 106 of the optical fiber joint 104, such that the optical fiber wires 1041 of the optical fiber joint 104 are allowed to be coupled to the optical fiber wires 2041 of the optical fiber socket 204. Furthermore, the photoelectric conversion element 202 is also mounted on the support 206 and respectively coupled to the transmission joint 201 and optical fiber socket 204, the transmission joint 201 being configured on another end of the support 206 and being a HDMI joint, USB join (see FIG. 13) or other kinds of standard transmission interface joints. Whereby, the optical fiber joint 104 of the transmission cable 100 is inserted in the optical fiber socket 204, allowing the optical fiber wires 1041 of the optical fiber joint 104 to be in connection with the optical fiber wires 2041 of the optical fiber socket 204. Thereupon, the signals in the transmission cable 100 can be transmitted directly through the optical fiber joint 104 or transmitted by means of the transformation of the photoelectric conversion element 202 to the transmission joint 201.

Next, referring to FIG. 8, the external power joint 205 may be replaced with the electrical conductors 101 in connection with transmission cable 100, and the high-speed transmission device 200 may still obtain the electric energy needed for operation from the electric power provided by the external power line 300 through the electrical conductors 101 if the power source joint 203 is not provided. It is namely that the present invention may transmit electric power to the conducting joint 203 of the high-speed transmission device 200 in electric connection with the conducting joint 103 of the electrical conductors 101, and the electric power in turn is transmitted to photoelectric conversion element 202 via the circuit of the support 206, and then to the transmission joint 201. Naturally, the electric power may also be transmitted to the transmission joint 201 directly via the circuit of the support 201 rather than through the photoelectric conversion element 202. Therefore, this circuit trace may provide the electric energy needed upon the operation of the high-speed transmission device 200.

To sum up, the present invention is a detachable high-speed transmission cable and a module thereof in which optical fiber is adopted to transmit signals. A transmission joint of standard transmission interface is not configured on the high-speed transmission cable of the present invention, and video/audio signals and control signals are respectively coupled through the conducting joint 103 of the transmission cable 100, conducting joint 203 of the high-speed transmission device 200 and the optical fiber joint 104 of the transmission cable 100, optical fiber socket 204 of the high-speed transmission device 200, and in turn input to the high-speed transmission device 200 and then transmitted to the transmission joint 201 of standard transmission interface after being transformed into electric signals. Therefore, the present invention is first characterized in that a user may replace every kind of high-speed transmission device 200 depending on requirements; it is namely that a transmission joint can be changed without needing to prepare various transmission cables in response to a wide range of applications. Specially, the transmission cable 100 without a joint may be erected first and the high speed transmission device 200 is then connected thereto after the installment of the transmission cable 100 is done so as to complete the assembly if the high-speed transmission cable of the present invention is adopted upon the construction of the arrangement of pipelines because the section of the transmission joint is much larger than the one of the transmission cable in size. Therefore, the present invention is further characterized in that the procedures of pipeline wiring can be simplified and the erection cost can be decreased.

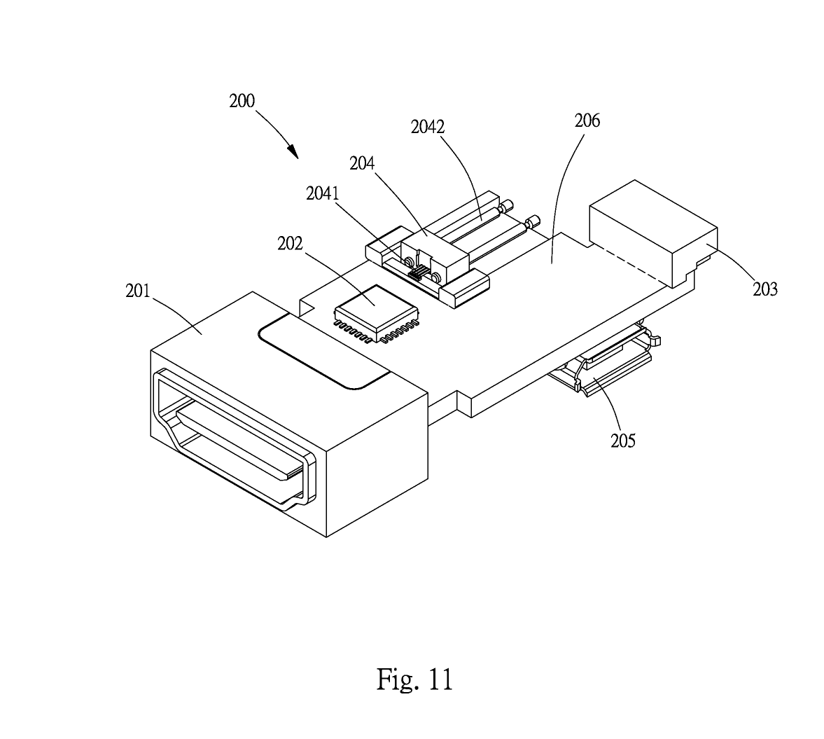

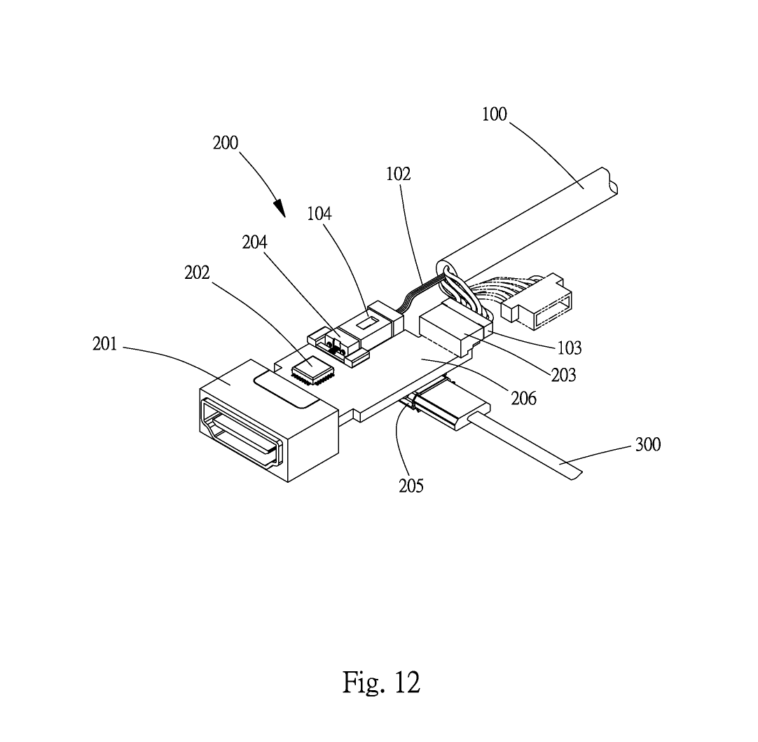

Referring to FIGS. 11 and 12, under the conditions of the external power joint 205 in connection with the external power line 300 and the conducting joint 103 of the high-speed transmission cable 100 in connection with the conducting joint 203 of the high-speed transmission device 200, the both can provide the high-speed transmission device 200 with electric power. As to the condition of the external power joint 205 being not connected to the external power line 300, the high-speed transmission device 200, the electrical conductors 101 in connection with the transmission cable 100 may be used to substitute for the external power line in connection with the external power joint 205 to provide electric power needed for operation. On the other hand, under the condition of the conducting joint 103 of the high-speed transmission cable 100 being not connected the conducting joint 203 of the high-speed transmission device 200, the high-speed transmission device 200 can still obtain alternate external power from the external power joint 205.

Referring to FIG. 13, which is a schematically perspective view of the present invention in which a USB is adopted as a transmission joint, the high-speed transmission device 200 includes a conducting joint 203, optical fiber socket 204, photoelectric conversion element 202 and transmission joint 201, where the transmission joint 201 in this embodiment is a USB joint, and the working principle of the high-speed transmission device 200 is similar to the embodiments mentioned above.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. (canceled)

2. (canceled)

3. (canceled)

4. (canceled)

5. (canceled)

6. (canceled)

7. (canceled)

8. (canceled)

9. (canceled)

10. (canceled)

11. A high-speed transmission cable module, comprising:
a transmission cable, having at least one optical fiber wire, and one end or two ends of said optical fiber wire being respectively in optical connection with an optical fiber joint.

12. The module according to claim 11, wherein said transmission cable further comprises at least one electrical conductor, and one end or two ends of said electrical conductor respectively are in electric connection with a conducting joint.

13. The module according to claim 11, wherein an intermediate area between said electrical conductor and said optical fiber wire of said transmission cable is wrapped commonly by a wire cladding skin, and two ends of said transmission cable where said cladding skin is removed to allow said electrical conductor and said optical fiber wire be in electric and optical connection with said conducting joint and optical fiber joint, respectively.

14. The module according to claim 11, wherein said optical fiber joint is configured with at least one guide hole.

15. The module according to claim 11, wherein said optical fiber joint is configured with at least one fiber hole.

16. A high-speed transmission device, having an optical fiber socket capable of being in optical connection with said optical fiber joint of said transmission cable and a transmission joint conforming to standard transmission interface, wherein signals of said optical fiber socket is transmitted directly to or coupled by means of transformation to said transmission joint.

17. The device according to claim 16, wherein said transmission device further comprises another conductor joint capable of being in electric connection with said conducting joint, wherein signals in said another conducting joint is transmitted directly or transmitted by means of transformation to said transmission joint.

18. The device according to claim 16, wherein said transmission device further comprises a photoelectric conversion element in connection with said optical fiber socket and transmission joint.

19. The device according to claim 16, wherein said transmission device further comprises an external power joint capable of the provision of external power.

20. The device according to claim 16, wherein said optical fiber socket is configured with at least one guide element.

21. The device according to claim 16, wherein said optical fiber socket is configured with at least one optical fiber wire.

22. The device according to claim 16, wherein components of said transmission device are configured on a support, wherein said support is a substrate.

23. A high-speed transmission cable module, comprising:
a transmission cable, having at least one optical fiber wire, and one end or two ends of said optical fiber wire being respectively in optical connection with an optical fiber joint; and
at least one transmission device, having an optical fiber socket capable of being in optical connection with said optical fiber joint of said transmission cable and a transmission joint conforming to standard transmission interface, wherein signals of said optical fiber socket is transmitted directly to or coupled by means of transformation to said transmission joint.

24. The module according to claim 23, wherein said transmission cable further comprises at least one electrical conductor, and one end or two ends of said electrical conductor respectively are in electric connection with a conducting joint, wherein components of said transmission device are configured on a support, and said support is a substrate.

25. The module according to claim 24, wherein said transmission device further comprises another conductor joint capable of being in electric connection with said conducting joint, wherein signals in said another conducting joint is transmitted directly or transmitted by means of transformation to said transmission joint.

26. The module according to claim 24, wherein an intermediate area between said electrical conductor and said optical fiber wire of said transmission cable is wrapped commonly by a wire cladding skin, and two ends of said transmission cable where said cladding skin is removed to allow said electrical conductor and said optical fiber wire be in electric and optical connection with said conducting joint and optical fiber joint, respectively.

27. The module according to claim 23, wherein said transmission device further comprises a photoelectric conversion element in connection with said optical fiber socket and transmission joint.

28. The module according to claim 23, wherein said transmission device further comprises an external power joint capable of the provision of external power.

29. The module according to claim 23, wherein said optical fiber joint is configured with at least one guide hole, and at least one guide element corresponding to said guide hole is configured on said optical fiber socket.

30. The module according to claim 23, wherein said optical fiber joint is configured with at least one optical fiber wire, and said optical fiber socket is configured with at least one optical fiber wire corresponding to said optical fiber wire of said optical fiber joint.
